(19) United States
(12) Patent Application Publication
(10) Pub. No.: US 2016/0313577 A1
(43) Pub. Date: Oct. 27, 2016

(54) DUAL-JUNCTION OPTICAL MODULATOR AND THE METHOD TO MAKE THE SAME

(71) Applicant: LaXense Inc., Walnut, CA (US)

(72) Inventors: Xiaochen Sun, Chino Hills, CA (US); Ningning Feng, Arcadia, CA (US)

(73) Assignee: LaXense Inc., Walnut, CA (US)

(21) Appl. No.: 14/694,834

(22) Filed: Apr. 23, 2015

(51) Int. Cl. G02F 1/025

(52) U.S. Cl. CPC G02F 1/025; G02F 2001/0151

(57) ABSTRACT

An optical device includes a substrate and an optical rib waveguide structure formed of a slab and a rib. A vertically-oriented P-N-P or N-P-N dual-junction diode is formed inside the rib waveguide, including a first doped region, a second doped region and a third doped region electrically connected to the first doped region, where two P-N junctions are formed at the boundaries of the first and the second doped regions, and the second and the third doped regions, respectively. The depletion regions of the two junctions are substantially in the center of a guided optical mode propagating at the core region through the rib waveguide. The optical device further includes a first metal contact and a second metal contact in electrical contact with the first doped region and the second doped region, respectively.

### BACKGROUND OF THE INVENTION

### 1. Field of the Invention

The invention relates generally to optical devices. In particular, the invention relates to semiconductor based optical modulators.

2. Description of the Related Art

Optical modulators are key components in optical communication systems. Optical modulators are devices that convert electrical signals to optical signals. An optical modulator is traditionally made of bulk crystalline optical materials such as lithium niobate (LiNO₃) that have strong electro-optic effects. However, devices made of these materials tend to be expensive and lack capability of planar integration and a scalable manufacturing process such as the ubiquitous silicon wafer fabrication process. The ever-increasing demands for communication bandwidth require low-cost highly-integrated optical devices. Silicon photonics is an emerging technology that can provide a solution. As a key component, optical modulators made of silicon are highly demanded.

Silicon is not an electro-optic material therefore the free-carrier effect is mainly used for designing high speed optical modulators. Silicon modulators based on free-carrier effect have been extensively studied in the past decade. Among them, modulators utilizing reverse biased PN diodes have been the major approach because of its high speed performance and compatibility with low cost silicon CMOS processes. Under reverse bias, the depletion region of the PN diode junction changes therefore the free carrier density in the changed region varies, which results in a refractive index change of the waveguide and in turn optical phase change.

The current design of a silicon optical modulators is realized by either a vertically oriented PN diode or a laterally oriented PN diode on a silicon-on-insulator substrate as shown in FIGS. 1A and 1B respectively. The doping concentrations in these PN diodes are generally designed for optimal free carrier changes upon changes of applied bias. As a result, the depletion width at practical bias is usually less than 0.2 μm. Therefore, in order to achieve high modulation efficiency determined by the overlap between the depletion region and optical mode hence, the silicon waveguide is usually designed to be as small as about 0.2 μm. However, a larger waveguide size is usually desired for more tolerance on etching dimension and roughness as well as easier optical coupling to other a fiber or other optical devices.

In addition, crystalline SiGe, which is a compatible material in silicon CMOS processes and can be epitaxially grown on silicon, is a good choice for waveguide on silicon. In such case, the top silicon layer of a silicon-on-insulator substrate can be used as bottom cladding because its refractive index is less than that of SiGe. Such material structure enables a two-waveguide scheme, i.e. the SiGe/Si waveguide (silicon used as bottom cladding) is used for modulation, the silicon waveguide (silicon-on-insulator) is used for passive routing and coupling and a mode transformer (e.g. SiGe taper) can be used to transfer the optical mode from one to another. The main benefit of this design is to allow the use of a very large silicon waveguide (e.g. even as large as an optical fiber mode of around 10 μm) for easy optical coupling without sacrificing the modulation efficiency as the modulation is realized in the SiGe/Si waveguide which can be optimized independently. However, the optical mode size of the SiGe/Si waveguide is generally larger than 0.4 μm due to smaller refractive index contrast in SiGe/Si compared to Si/SiO2. Given the depletion width of the PN diode is less than 0.2 μm, the overlap between the optical mode and the depletion width, hence the modulation efficiency, is at least 50% less than the case of a waveguide mode size of 0.2 μm. New designs are needed if the SiGe/Si structure is used for its other benefits while maintaining the same modulation performance.

### SUMMARY OF THE INVENTION

The present invention is directed to an optical device and related fabrication method that substantially obviates one or more of the problems due to limitations and disadvantages of the related arts.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides an optical device comprising: a substrate; an optical rib waveguide structure formed of a slab and a rib; a vertically-oriented P-N-P or N-P-N dual-junction diode formed inside the rib waveguide, comprising a first doped region, a second doped region and a third doped region electrically connected to the first doped region, where two P-N junctions are formed at the boundaries of the first and the second doped regions, and the second and the third doped regions, respectively, and the depletion regions of the two junctions are substantially in the center of a guided optical mode propagating at the core region through the rib waveguide; a first metal contact and a second metal contact positioned in electrical contact with the first doped region and the second doped region, respectively.

In the first embodiment, the electrical connection between the first doped region and the second doped region is accomplished by the same type doping along the edge of the rib and the first metal contact is disposed on top of the first doped region.

In the second embodiment, the electrical connection between the first doped region and the second doped region is accomplished by a poly silicon layer doped with the same type of doping and disposed in contact with both the first doped region and the third doped region. In this case, the first metal contact is disposed on top of the poly silicon layer.

The optical device further comprises a first heavily doped region below the first metal contact and a second heavily doped region below the second metal contact for better Ohmic contact.

In both embodiments, the two P-N junctions are connected in parallel with the same anode metal contact and cathode metal contact to form a dual-junction diode. The depletion widths of both junctions may be changed by varying an applied reverse voltage applied between the first and the second metal contacts. The two depletion regions, where the free carrier concentration changed with applied voltage, increase the overlap with the optical mode compared to the single P-N junction in a relatively larger waveguide therefore increase the modulation efficiency.

It is to be understood that both the foregoing general description and the following detailed description are exemplary and explanatory and are intended to provide further explanation of the invention as claimed.

### BRIEF DESCRIPTION OF THE DRAWINGS

FIG. 1A (Prior Art) schematically illustrates the cross-sectional view of a rib waveguide silicon modulator using a vertical P-N diode.

FIG. 1B (Prior Art) schematically illustrates the cross-sectional view of a rib waveguide silicon modulator using a horizontal P-N diode.

FIG. 2 schematically illustrates the cross-sectional view of a rib waveguide silicon or SiGe modulator using a vertical N-P-N dual-junction diode, where the two N-regions are connected at the edge of the rib, according to a first embodiment of the present invention.

FIG. 3 schematically illustrates the cross-sectional view of a rib waveguide silicon or SiGe modulator using a vertical N-P-N dual-junction diode, where the two N-regions are connected through a poly silicon layer, according to a second embodiment of the present invention.

FIG. 4A illustrates the overlap between the optical mode and the depletion width of a P-N diode modulator.

FIG. 4B illustrates the overlap between the optical mode and the two depletion widths of a dual-junction diode modulator according to embodiments of the present invention.

FIG. 5 illustrates a group of calculated π phase shift length of a modulator using a P-N diode and a N-P-N dual-junction diode, respectively.

FIGS. 6A-6H schematically illustrate the steps of the process for fabricating the N-P-N dual-junction diode modulator shown in FIG. 2.

FIGS. 7A-7K schematically illustrate the steps of the process for fabricating the N-P-N dual-junction diode modulator shown in FIG. 3.

### DETAILED DESCRIPTION OF THE PREFERRED EMBODIMENTS

The invention relates to an optical device, in particular, a silicon or SiGe optical modulator using a rib waveguide structure fabricated on a substrate, and methods of making the same.

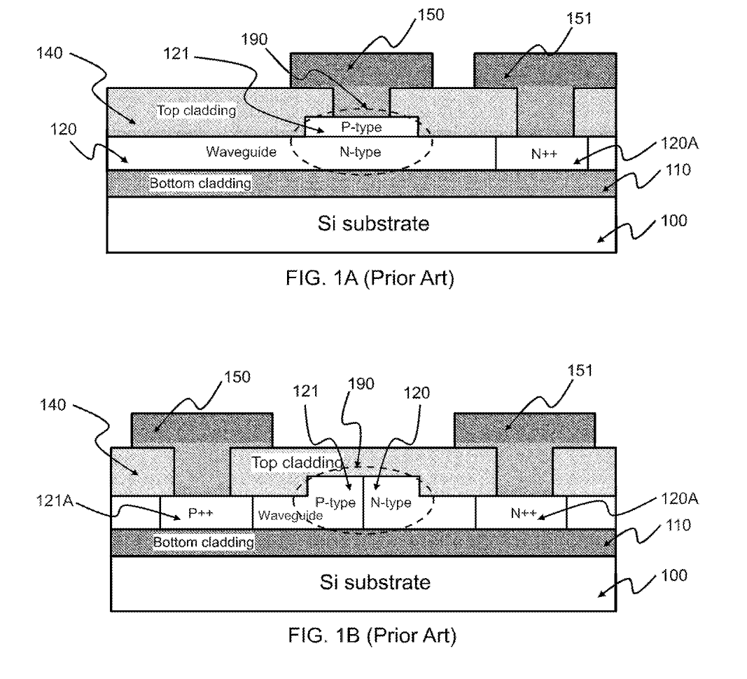

FIG. 1A and FIG. 1B schematically illustrates two prior arts rib waveguide silicon modulators using a vertical P-N diode and a horizontal P-N diode, respectively. It is known that the modulation efficiency of a carrier depletion modulator highly depends on the overlap of the carrier depletion region the PN junction and the optical mode 190. The P-N junction in both modulator designs in FIGS. 1A and 1B is located near the center of the optical mode. Nevertheless the depletion width is generally limited to less than 0.2 μm due to the choice of relatively high doping concentration in both P region 121 and N region 120 for better free carrier concentration changes by varying applied voltage between two metal contacts 150 and 151. When the optical mode is significantly larger than 0.2 μm due to reasons including larger silicon waveguide, the use of lower-refractive-index-contrast SiGe/Si waveguide design and etc., the overlap is limited no matter where the P-N junction is formed. This limitation of modulation efficiency is unavoidable whenever larger-than-0.2 μm optical mode is present.

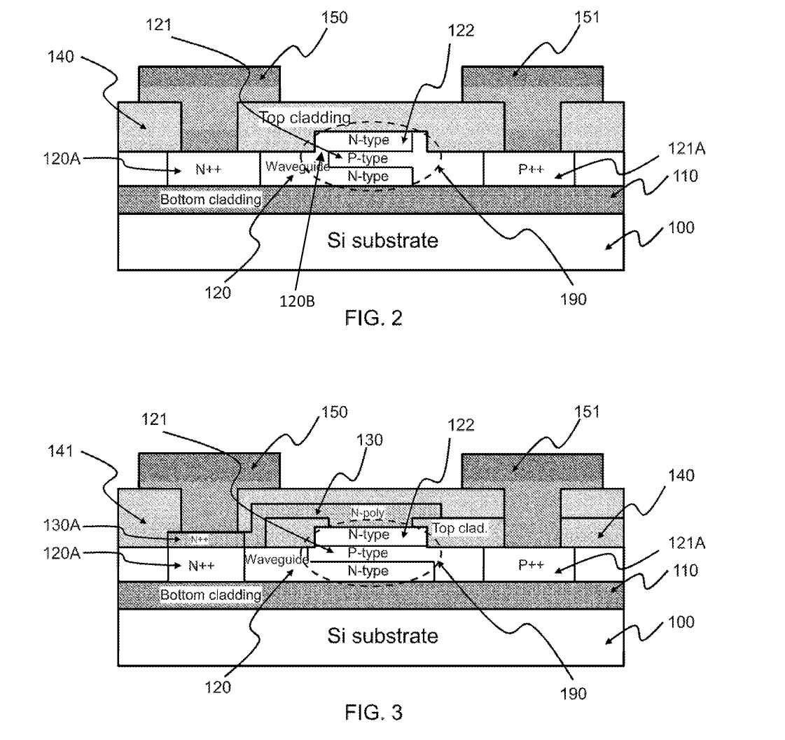

The cross-sectional view of the first embodiment of the present invention is schematically illustrated in FIG. 2. The rib waveguide modulator is formed on a substrate 100. The rib waveguide may be made of single-crystalline silicon which may be the top silicon layer of a silicon-on-insulator substrate which is generally a type of substrate with a single-crystalline silicon layer on top of an insulating layer, which includes but not limited to silicon oxide, silicon nitride, sapphire, and etc., disposed on a handling layer. In such case the insulating layer serves as bottom cladding 110 as its refractive index is generally smaller than that of silicon. The rib waveguide may also be made of SiGe alloy which is disposed on top of the substrate by epitaxial growth or other deposition methods. In this case, the substrate can be either a silicon bulk substrate serving as both bottom cladding 110 and handling substrate 100 or a silicon-on-insulator substrate where the silicon layer and the insulator layer serve as the bottom cladding 110. In the case of the silicon-on-insulator substrate, the top silicon layer can also form a waveguide using the insulator layer as bottom cladding where the SiGe layer is removed. A careful design of a mode transformer structure where the SiGe layer is removed in a gradual changing fashion enables a low loss transfer between the SiGe/Si waveguide mode and the Si waveguide mode. As the silicon waveguide may be designed with a large size without affecting the SiGe/Si waveguide mode, this two-waveguide system may achieve both high modulation efficiency by using the small SiGe/Si waveguide and easy waveguide facet coupling by using the large silicon waveguide.

A vertically-oriented N-P-N dual-junction diode is formed inside the rib waveguide, comprising a first doped region (N-type) 120 occupying the first slab region and the bottom part of the core region adjacent to the substrate, a second doped region (P-type) 121 occupying the second slab region and the middle part of the core region on top of the first doping region in the core region, and a third doped region (N-type) 122 occupying the top part of the core region, which is substantially inside of the rib and is connected to the first doped region by a connecting region 120B (N-type) along the edge of the rib. The two PN junctions are formed at the boundary of the first and the second doped regions, and the second and the third doped regions, respectively. The depletion regions of the two junctions are substantially in the center of a guided optical mode 190 propagating at the core region through the rib waveguide.

A dielectric layer 140 is disposed on top of the rib waveguide serving as both electrical isolation and top cladding of the waveguide. The layer may be made from materials including, but not limited to, silicon oxide, silicon nitride, insulating polymers.

A first metal contact 150 and a second metal contact 151 are disposed on top of the dielectric layer 140. The first metal contact 150 electrically connects to the first doped region 120 via a contact window etched through the dielectric layer 140. The second metal contact 151 electrically connects to the first doped region 121 via a contact window etched through the dielectric layer 140.

A first heavily doped region 120A is formed as part of the first doped region 120 underneath the first metal contact 150. The region 120A is doped to N-type with higher concentration than the rest of the first doped region 120 to achieve a good Ohmic metal-semiconductor contact. Similarly, a second heavily doped region 121A is formed as part of the second doped region 121 underneath the second metal contact 151. The region 121A is doped to P-type with higher concentration than the rest of the second doped region 121. The size of the two depletion regions in the two PN junctions, respectively, may be changed by varying an applied reverse voltage applied between the first metal contact 150 and the second metal contact 151. The changing of the size of the depletion regions changes the effective refractive index of the rib waveguide which changes the phase of the guided optical wave through the rib waveguide. Therefore, it can be used as a phase modulator. In addition, when this phase modulator is adopted to construct a Mach-Zehnder interferometer, a ring resonator or similar optical circuit, it can realize intensity modulator.

The cross-sectional view of the second embodiment of the present invention is schematically illustrated in FIG. 3. Compared with the first embodiment illustrated in FIG. 2, the connection between the first doped region 120 and the third doped region 122 is achieved by a poly silicon layer 130 which is also doped with N-type, instead of through the edge of the rib. In addition, the first heavily doped region 120A extends to part of the poly silicon region beneath the first metal contact 150, and the first metal contact 150 electrically contacts with the poly silicon. Layer 141 is another dielectric layer.

It can be seen that the nature of the invention does not change if the doping type of the first region 120 and the third region 122 is changed to P-type while the doping type of the second region 121 is changed to N-type.

In both embodiments, the two P-N junctions are connected in parallel with the same anode metal contact and cathode metal contact, respectively, to effectively form a dual-junction diode. The depletion widths of both junctions may be changed by varying an applied reverse voltage applied between the first and the second metal contacts.

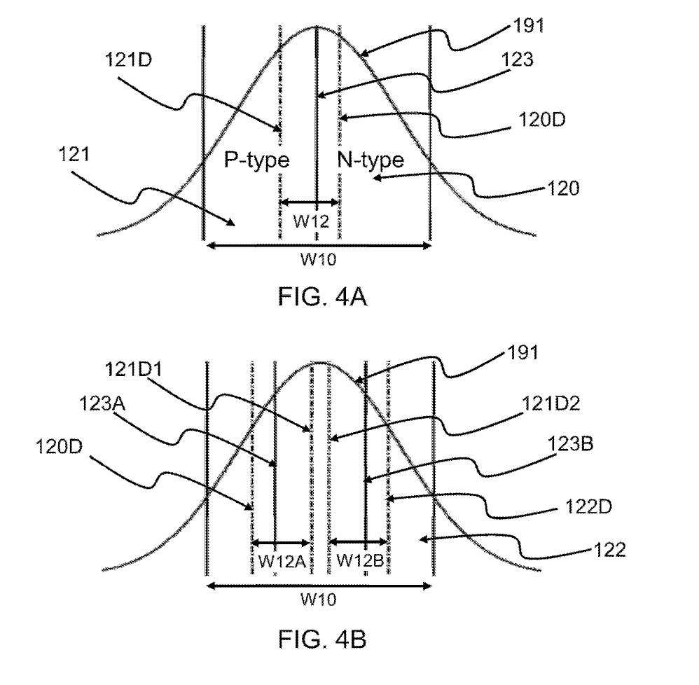

FIG. 4A illustrates the overlap between the optical mode 191 and the depletion width W12, defined by the depletion boundary 121D in the P-region and the boundary 120D in the N-region, of a P-N diode modulator, while FIG. 4B illustrates the overlap between the optical mode 191 and the two depletion widths W12A and W12B, defined by the depletion boundary 120D in the first P-region and the boundary 121D1 in the N-region, and the depletion boundary 121D2 in the N-region and the boundary 122D in the second P-region, of a dual-junction diode modulator. By comparing the two cases, it can be seen that the two depletion regions, where the free carrier concentration changed with applied voltage, increase the overlap with the optical mode 191 compared to the single P-N junction in a relatively larger waveguide therefore increase the modulation efficiency.

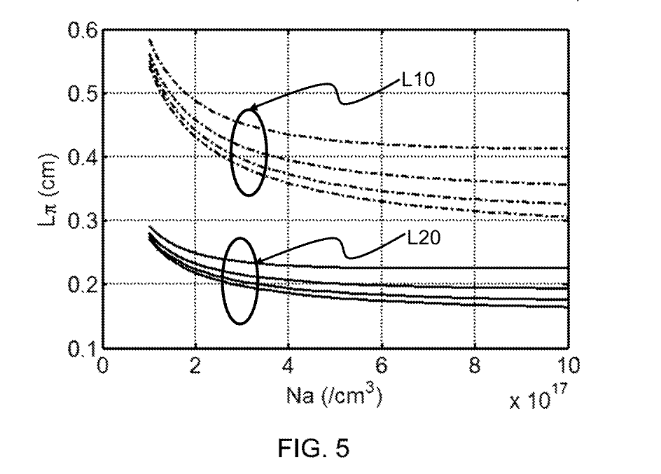

FIG. 5 illustrates a group of calculated π phase shift length L10 of a modulator using a P-N diode and a group of calculated π phase shift length L20 of an N-P-N dual-junction diode as function of P-doping concentration and with four different N-doping concentration at the same 3V reverse voltage for a 0.5 μm thick SiGe/Si waveguide. The ranges of the P-doping and N-doping concentrations are chosen for reasonable free carrier effect and optical loss. The it phase shift length is a value representing the waveguide length required for modulator devices and shorter length means higher modulation efficiency and lower optical loss. It can be seen that the increase of P-doping and N-doping concentration generally results in short length however the effect becomes saturated at higher doping concentrations due to the smaller overlap between optical mode and the depletion width as a result of the decrease of the depletion width with higher doping concentrations. Therefore there is a theoretical limit of the it phase shift length for a P-N diode design. With the dual-junction N-P-N design, this theoretical limit of the π phase shift length is nearly half of that in the P-N diode design. It means the dual-junction design nearly doubles the modulation efficiency.

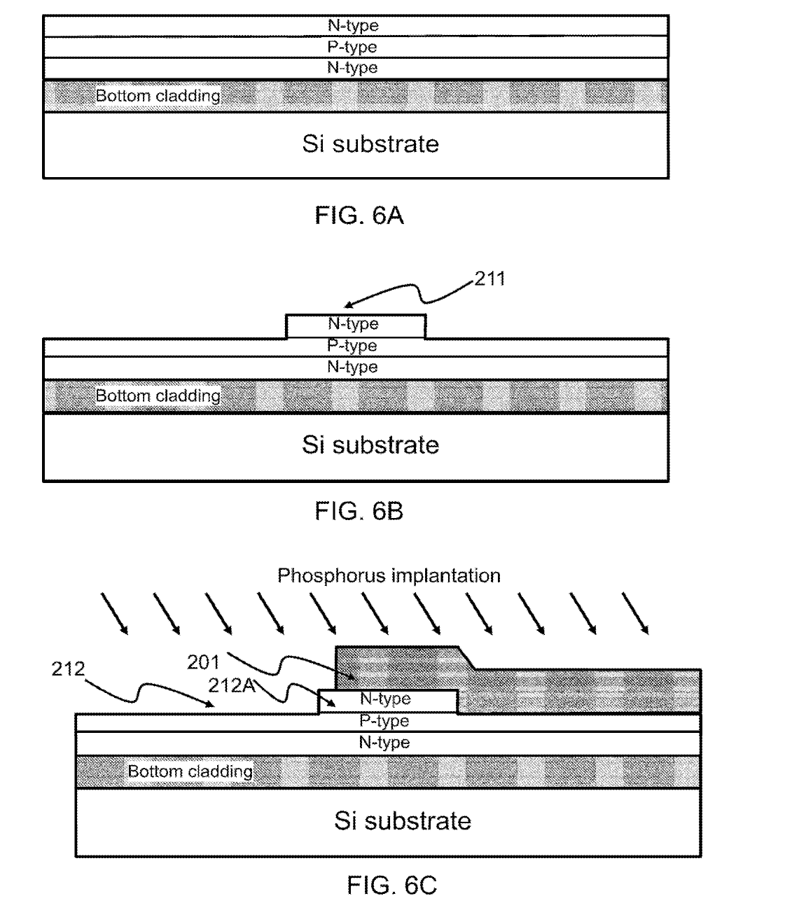

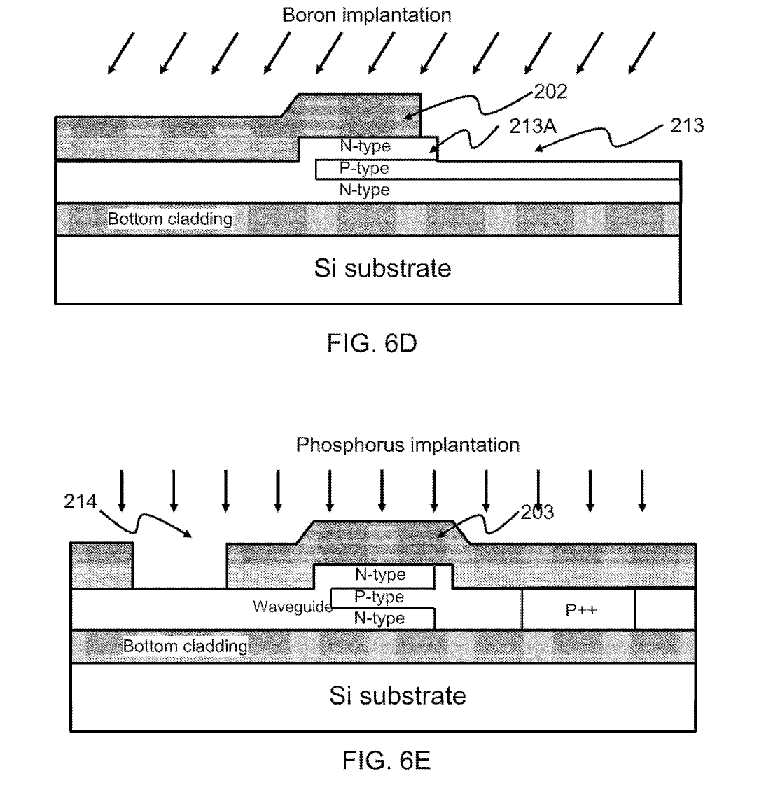

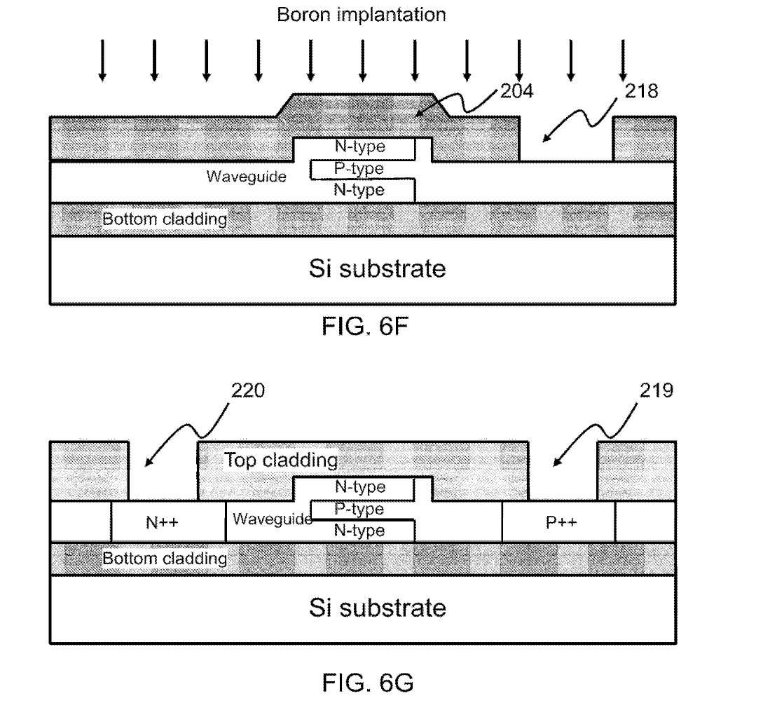

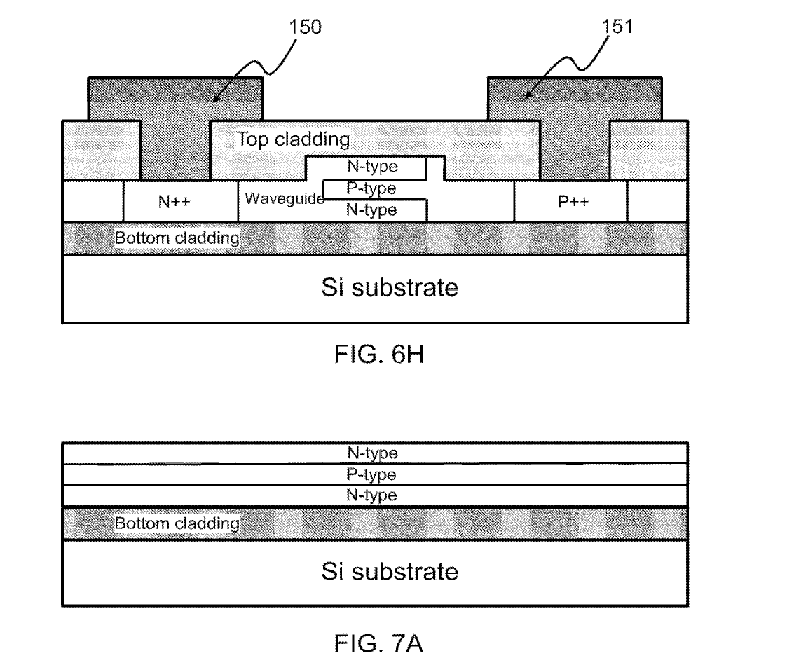

FIGS. 6A-6H schematically illustrate the steps of the process for fabricating the N-P-N dual-junction diode modulator shown in FIG. 2. The process begins (FIG. 6A) with a substrate 100 described earlier disposed with a bottom cladding layer 110 and a waveguide material comprised of three layers with N-type, P-type and N-type doping in sequence. The material can be grown or deposited on the substrate and is doped by intrinsic doping during the growth or deposition or by carefully designed ion-implantation, both of which are standard procedures in silicon semiconductor processing.

The first step (FIG. 6B) is to photolithographically pattern and etch a rib waveguide 211. The etch depth is equal or more than the thickness of the top N-doped layer but less than the total thickness of the top N-doped layer and the P-doped layer.

The next step (FIG. 6C) is to use photolithographically patterned photoresist 201 as mask to protect one side of the slab and the most part of the rib to expose a small shoulder 212A. Then to implant N-type ions with an angle towards the protected side in order to compensate the exposed slab 212 and the small shoulder 212A from P-type to N-type in order to connect the top N-type and the bottom N-layer.

The next step (FIG. 6D) is to use photolithographically patterned photoresist 202 as mask to protect the other side of the slab and the most part of the rib to expose a small shoulder 213A. Then to implant P-type ions with an angle towards the protected side in order to compensate the bottom N-type layer under the exposed slab 213 and the small shoulder 213A from N-type to P-type in order to restrict the P-N junction only within the vicinity of the rib waveguide center.

The next step (FIG. 6E) is to use photolithographically patterned photoresist 203 as mask to expose an area 214 on the first slab side and to heavily implant N-type ions into the slab.

The next step (FIG. 6F) is to use photolithographically patterned photoresist 204 as mask to expose an area 218 on the second slab side and to heavily implant P-type ions into the slab.

The next step (FIG. 6G) is to deposit a dielectric layer and photolithographically pattern the layer and etch contact windows 219 and 220 to expose the heavily doped areas 214 and 218.

The final step (FIG. 6H) is to deposit a metal layer and photolithographically pattern the layer to form two electric contacts 150 and 151.

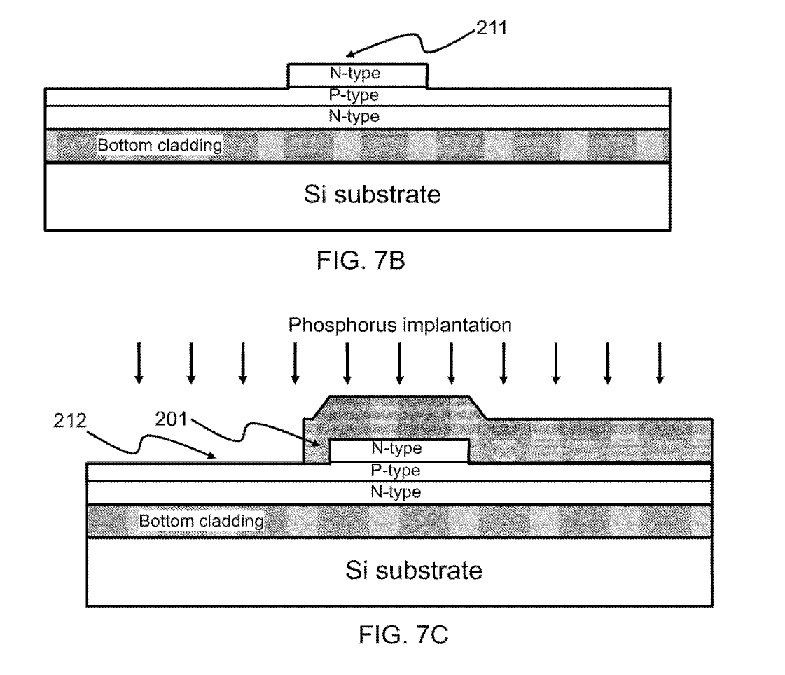

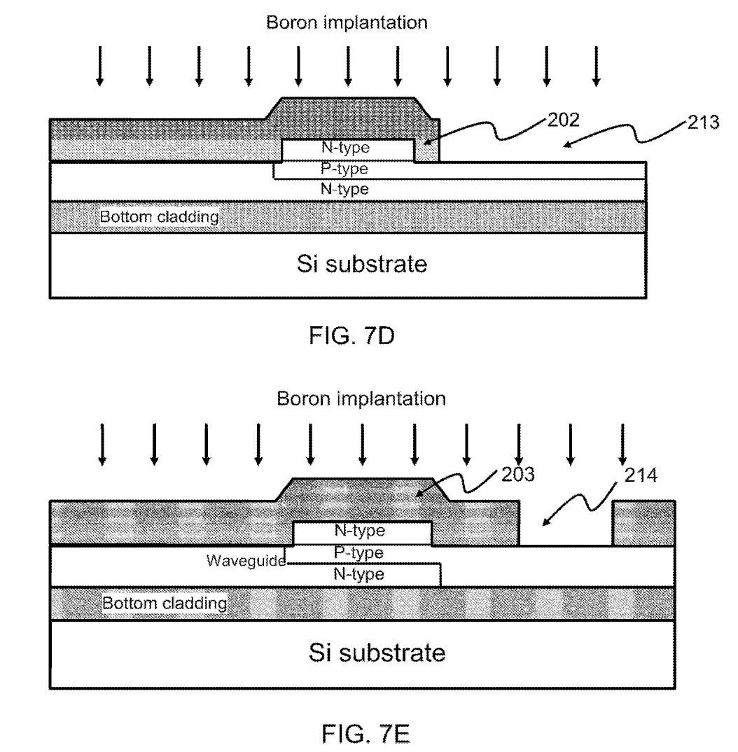

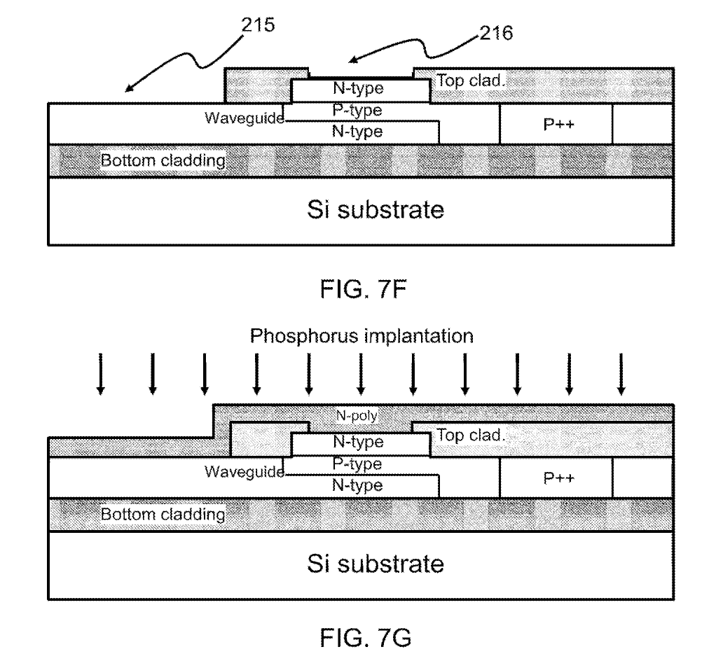

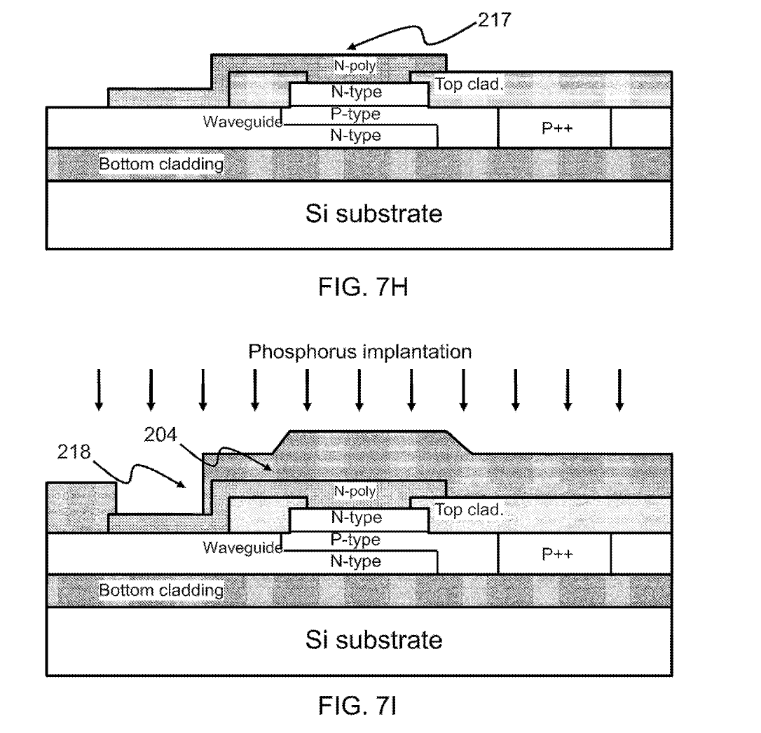

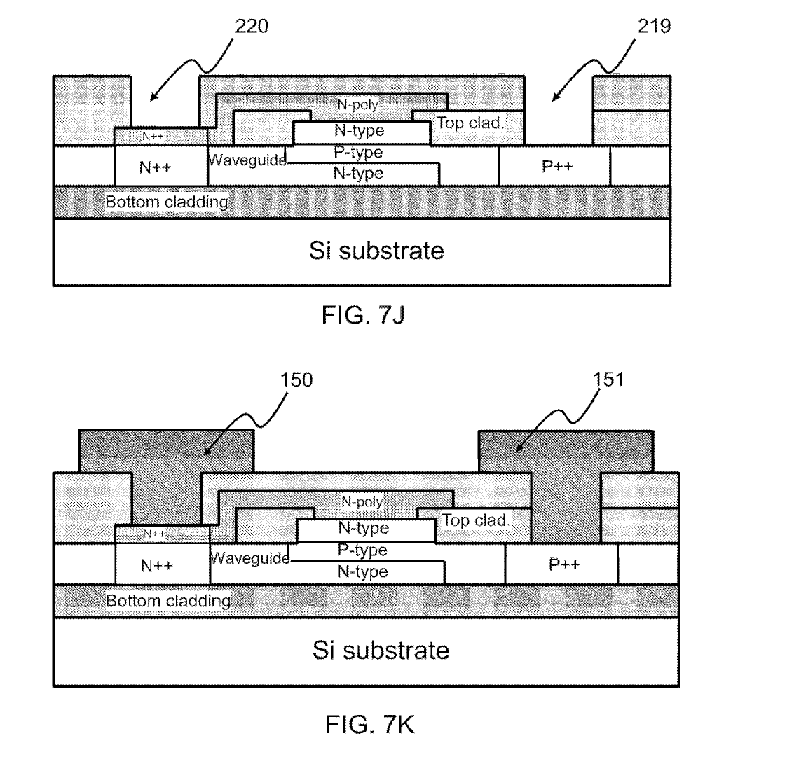

FIG. 7A-7K schematically illustrate the steps of the process for fabricating the N-P-N dual-junction diode modulator shown in FIG. 3. The start substrate and material structure is the same as shown in FIG. 6A and the first step (FIG. 7B) is the same rib waveguide definition as shown in FIG. 6B.

The next step (FIG. 7C) is to use photolithographically patterned photoresist 201 as mask to protect one side of the slab and the entire rib. Then to implant N-type ions in order to compensate the exposed slab 212 from P-type to N-type.

The next step (FIG. 7D) is to use photolithographically patterned photoresist 202 as mask to protect the other side of the slab and the entire rib. Then to implant P-type ions in order to compensate the bottom N-type layer under the exposed slab 213 from N-type to P-type in order to restrict the P-N junction only within the vicinity of the rib waveguide center.

The next step (FIG. 7E) is to use photolithographically patterned photoresist 203 as mask to expose an area 214 on the second slab side and to heavily implant P-type ions into the slab.

The next step (FIG. 7F) is to deposit a dielectric layer and photolithographically pattern the layer and etch contact windows to expose the first side slab 215 and most part of the rib 216.

The next step (FIG. 7G) is to deposit a poly silicon layer and to implant N-type ions in the entire layer.

The next step (FIG. 7H) is to photolithographically pattern the poly silicon layer to leave the area on top of the rib and a certain part of the first side slab 217.

The next step (FIG. 7I) is to use photolithographically patterned photoresist 204 as mask to expose an area 218 on the first slab side and part of the poly silicon and to heavily implant N-type ions into the slab.

The next step (FIG. 7J) is to deposit a dielectric layer and photolithographically pattern the layer and etch contact windows 219 and 220 to expose the heavily doped areas 214 and 218.

The final step (FIG. 7K) is to deposit a metal layer and photolithographically pattern the layer to form two electric contacts 150 and 151.

It will be apparent to those skilled in the art that various modification and variations can be made in the optical system and related fabrication methods of the present invention without departing from the spirit or scope of the invention. Thus, it is intended that the present invention cover modifications and variations that come within the scope of the appended claims and their equivalents.

What is claimed is:

1. An optical device on a substrate, comprising:
a slab formed on top of the substrate;
a rib formed on the top of the slab;
wherein the rib and a part of the slab below the rib define a core region;
wherein the slab region includes a first slab region at one side of the core region, and a second slab region at another side of the core region opposite the first slab region, the core region and the first and second slab regions forming a rib optical waveguide;
wherein the first slab region and a bottom part of the core region adjacent to the substrate form a first doped region of a first dopant type (N-type or P-type), wherein the second slab region and a middle part of the core region on top of the bottom part of the core region form a second doped region of a second dopant type which is opposite of the first dopant type (N-type or P-type), wherein a top part of the core region on top of the middle part and located substantially inside the rib form a third doped region of the first dopant type, and wherein the third doped region is connected to the first doped region by a doped connecting region of the first dopant type which is located along an edge of the rib,
wherein the first, second and third doped regions form a vertically-oriented P-N-P or N-P-N dual-junction diode inside the rib, including two PN junctions are formed at boundaries of the first and second doped regions and the second and third doped regions, respectively, and wherein depletion regions of the two PN junctions are substantially located at a center of a guided optical mode propagating in the core region through the rib optical waveguide;
a first metal contact positioned in electrical contact with the first doped region at the first slab region; and
a second metal contact positioned in electrical contact with the second doped region at the second slab region.

2. The optical device of claim 1, wherein a part of the first slab region below a contact area of the first metal contact is a first heavily doped region with a same doping type as the first doping region a but higher doping concentration, and
wherein a part of the second slab region below a contact area of the second metal contact is a second heavily doped region with a same doping type as the second doping region but a higher doping concentration.

3. The optical device of claim 1, wherein the substrate and the rib waveguide are made of a combination of materials selected from a group consisting of:
single crystalline silicon as the substrate and a layer of single crystalline silicon-germanium alloy as the rib waveguide;
a layer of silicon dioxide, silicon nitride, or sapphire disposed on top of the silicon as the substrate and a layer single crystalline silicon or polycrystalline silicon as the rib waveguide; and
a silicon-on-insulator (SOI) as both the substrate and the rib waveguide.

4. The optical device of claim 1, wherein sizes of the depletion regions of the two PN junctions, respectively, are variable depending on an applied reverse voltage applied between the first and the second metal contacts.

5. The optical device of claim 4, wherein variations of the sizes of the depletion regions changes an effective refractive index of the rib optical waveguide which changes a phase of the guided optical wave through the rib waveguide

6. An optical device on a substrate, comprising:
a slab formed on top of the substrate;
a rib formed on the top of the slab;
wherein the rib and a part of the slab below the rib define a core region;
wherein the slab region includes a first slab region at one side of the core region, and a second slab region at another side of the core region opposite the first slab region, the core region and the first and second slab regions forming a rib optical waveguide;
wherein the first slab region and a bottom part of the core region adjacent to the substrate form a first doped region of a first dopant type (N-type or P-type), wherein the second slab region and a middle part of the core region on top of the bottom part of the core region form a second doped region of a second dopant type which is opposite of the first dopant type (N-type or P-type), wherein a top part of the core region on top of the middle part and located substantially inside the rib form a third doped region of the first dopant type,
wherein the first, second and third doped regions form a vertically-oriented P-N-P or N-P-N dual-junction diode inside the rib, including two PN junctions are formed at boundaries of the first and second doped regions and the second and third doped regions, respectively, and wherein depletion regions of the two PN junctions are substantially located at a center of a guided optical mode propagating in the core region through the rib optical waveguide;
a polycrystalline silicon layer with a same dopant type as the third doped region, formed on top of the rib waveguide, electrically connected to the first and the third doped regions and electrically insulated from the second doped region;
a first metal contact positioned in electrical contact with the polycrystalline layer; and
a second metal contact positioned in electrical contact with the second doped region at the second slab region.

7. The optical device of claim 6, wherein a part of the polycrystalline silicon layer below a contact area of the first metal contact is a heavily doped region with a same doping type as the first doping region a but higher doping concentration,
wherein a part of the first slab region below the heavily doped region of the polycrystalline silicon layer is a first heavily doped region with a same doping type as the first doping region a but higher doping concentration, and
wherein a part of the second slab region below a contact area of the second metal contact is a second heavily doped region with a same doping type as the second doping region but a higher doping concentration.

8. The optical device of claim 6, wherein the substrate and the rib waveguide are made of a combination of materials selected from a group consisting of:
single crystalline silicon as the substrate and a layer of single crystalline silicon-germanium alloy as the rib waveguide;
a layer of silicon dioxide, silicon nitride, or sapphire disposed on top of the silicon as the substrate and a layer single crystalline silicon or polycrystalline silicon as the rib waveguide; and
a silicon-on-insulator (SOI) as both the substrate and the rib waveguide.

9. The optical device of claim 6, wherein sizes of the depletion regions of the two PN junctions, respectively, are variable depending on an applied reverse voltage applied between the first and the second metal contacts.

10. The optical device of claim 9, wherein variations of the sizes of the depletion regions changes an effective refractive index of the rib optical waveguide which changes a phase of the guided optical wave through the rib waveguide
